(19) United States
(12) Patent Application Publication
(10) Pub. No.: US 2005/0083260 A1
(43) Pub. Date: Apr. 21, 2005

(54) Driving apparatus for plasma display panel and a gray level expressing method thereof

(76) Inventor: Seung-Ho Park, Suwon-si (KR)

Correspondence Address: CHRISTIE, PARKER & HALE, LLP, PO BOX 7068, PASADENA, CA, 91109-7068, US

(21) Appl. No.: 10/963,931

(22) Filed: Oct. 12, 2004

(30) Foreign Application Priority Data
Oct. 16, 2003 (KR) 10-2003-0072354

(51) Int. Cl. G09G 3/28; G09G 5/02

(52) U.S. Cl. 345/60

(57) ABSTRACT

A plasma display panel (PDP) driving apparatus and a gray level expressing method thereof that improves an expression of the gray level using a subfield arrangement that depends on sustain pulses. An input image signal undergoes inverse gamma correction so that an inverse gamma correction gray level corresponding to a number of sustain pulses applied to the PDP is expressed. The inverse gamma correction gray level is converted to subfields that depend on the number of sustain pulses. Alternatively to providing an arbitrary sustain pulse number, the sustain pulse number may be determined per frame according to an average signal level in the input image signal. Then, the inverse gamma table may be determined differently based on the sustain pulse number so as to express the inverse gamma gray level corresponding to the sustain pulse number.

### CROSS REFERENCE TO RELATED APPLICATION

This application claims priority to and the benefit of Korea Patent Application No. 10-2003-0072354 filed on Oct. 16, 2003 in the Korean Intellectual Property Office, the entire content of which is incorporated herein by reference.

### BACKGROUND OF THE INVENTION

(a) Field of the Invention

The present invention relates to a driving apparatus for a plasma display panel and a gray level expressing method thereof, and more particularly, to a driving apparatus for a plasma display panel and a gray level expressing method thereof that can provide an improved expression of gray level.

(b) Description of the Related Art

Flat panel displays such as a liquid crystal display (LCD), a field emission display (FED), a plasma display panel, or the like have been developed recently. Among the flat panel displays, the plasma display panel has advantages in that it has a wide visual range and that the brightness and light-emitting efficiency are high in comparison with other types of flat panel displays. The plasma display panel is in the spotlight as a display that can be substituted for the conventional cathode ray tube (CRT), especially in the large-sized displays of greater than forty inches.

The plasma display panel is a flat panel display that can display characters or images using plasma generated by gas discharge, on which hundreds of thousands or millions of pixels are arranged in a matrix format according to the size thereof. Such a plasma display panel is classified as a direct current type or an alternating current type according to the structure of discharging cells and the shape of the waveform of the driving voltage applied thereto.

The direct current type plasma display panel has a shortcoming in that a current flows in a discharge space while the voltage is being applied as the electrodes are exposed to the outside while the discharge space is not insulated. Because of this, a resistor for confining the current needs to be implemented. To the contrary, the alternating current type plasma display panel has an advantage in that the current is confined by capacitance formed naturally and the electrodes are protected by the impact from ions during the discharge by the dielectric layer covering the electrodes, so the lifetime is longer than that of the direct current type.

FIG. 1 is a partial perspective view of an alternating current type plasma display panel.

As shown in FIG. 1, scan electrodes 4 and sustain electrodes 5 covered by a dielectric layer 2 and a protection layer 3 are formed in parallel in pairs on a glass substrate 1. A plurality of address electrodes 8 covered by an insulation layer 7 are formed on another glass substrate 6. Partitioning walls 9 are formed in parallel with the address electrodes 8 on the insulation layer 7 between the address electrodes 8, and fluorescent substances 10 are formed on the surface of the insulating layer 7 and both sides of the partitioning walls 9. The glass substrates 1 and 6 face each other with discharge spaces 11 between them so that the scan electrodes 4 and the sustain electrodes 5 are perpendicular to the address electrodes 8. Discharge spaces near intersections between the address electrodes 8 and the scan electrodes 4 and sustain electrodes 5 that are paired with each other form discharge cells 12.

FIG. 2 shows an arrangement of the electrodes in the plasma display panel.

As shown in FIG. 2, the electrodes in the plasma display panel are arranged in m×n matrix form, and more particularly, address electrodes A1-Am are arranged in a column direction and n rows of the scan electrodes Y1-Yn and the sustain electrodes X1-Xn are arranged alternately in a row direction. The discharge cell 12 in FIG. 2 corresponds to the discharge cell 12 in FIG. 1.

The driving period of such an alternating current type plasma display panel includes a reset time, an addressing time, and a sustain time according to the time flow of the change of the operation.

The reset time is the period to initialize the status of the respective cells in order to enhance the performance of the addressing operation of the cells, and the addressing time is the period to form a wall charge by applying the address voltage to the cells to be turned on (addressed cell) in order to select the cells to be turned on and not to be turned on in the panel. The sustain time is the discharge period for displaying the image actually on the addressed cells by applying sustain pulses.

As shown in FIG. 3, the plasma display panel realizes a gray level by dividing one frame (e.g., 1TV field) into a plurality of subfields and then performing time-divisional control thereon. The respective subfields include the reset time, the addressing time, and the sustain time as described above. FIG. 3 shows the case in which one frame is divided into eight subfields in order to realize 256 gray levels. The respective subfields SF1-SF8 include a reset time (not shown), an addressing time Ad1-Ad8, and a sustain time S1-S8. In the sustain time S1-S8, the ratio of illuminating times 1T, 2T, 4T, . . . , and 128T is 1:2:4:8:16:32:64:128.

In such a situation, in order to realize the gray level of 3 for example, the sum of the discharging time is made to be 3T by discharging the discharge cells at the subfield SF1 having the illuminating time 1T and the subfield SF2 having the illuminating time 2T. The image of 256 gray levels can therefore be realized by combining the subfields having different illuminating times.

Further, according to the conventional method of expressing the gray level of the plasma display panel, the number of pulses allotted to the respective subfields is determined by a multiple of the subfield weight corresponding to the sustain time as shown in FIG. 3 according to the average gray level at every frame. In other words, the number of sustain pulses is changed according to the average gray level of every frame in order to increase the contrast between the frames and simultaneously decrease the power consumption. For example, to express 256 gray levels, four times the subfield weight is employed in the case of a low average gray level in order to assign many sustain pulses, and two times the subfield weight is employed in the case of a high average gray level in order to assign a small number of sustain pulses. Therefore, the conventional method is limited in enhancing the expression of the gray level since the gray level is expressed only by increasing the total sum of the sustain by multiplying a certain number to the subfield weight determined only in consideration of the gray level irrespective of the sustain pulse number.

### SUMMARY OF THE INVENTION

In exemplary embodiments according to the present invention, is provided a driving apparatus for a plasma display panel and a method for expressing gray levels thereof, in which the expression of the gray levels is improved by expressing gray levels of as many as a maximum number of sustain pulses.

In one aspect of the present invention, there is provided a driving apparatus for a plasma display panel that divides each field of an image displayed on the plasma display panel according to an input image signal into a plurality of subfields and displays the image corresponding to the image signal by expressing gray levels using a combination of the subfields. The driving apparatus includes an inverse gamma corrector, a sustain pulse subfield converter, and a sustain/scan driver. The inverse gamma corrector performs inverse gamma correction of the input image signal to express an inverse gamma correction gray level corresponding to a number of sustain pulses applied to the plasma display panel. The sustain pulse subfield converter converts the inverse gamma correction gray level to the subfields that depend on the number of sustain pulses. The sustain/scan driver generates control signals based on an arrangement of the subfields and applies the control signals to the plasma display panel.

According to another aspect of the present invention, there is provided a method for expressing gray levels of a plasma display panel that divides each field of an image displayed on the plasma display panel according to an input image signal into a plurality of subfields and displays the image corresponding to the image signal by expressing gray levels using a combination of the subfields. In the method, inverse gamma correction of the input image signal is performed to express an inverse gamma correction gray level corresponding to a number of sustain pulses applied to the plasma display panel. The inverse gamma correction gray level is converted to the subfields that depend on the number of sustain pulses. Control signals are generated based on an arrangement of the subfields to display the image on the plasma display panel.

According to still another aspect of the present invention, there is provided a driving apparatus for a plasma display panel that divides each field of an image displayed on the plasma display panel according to an input image signal into a plurality of subfields and displays the image corresponding to the image signal by expressing gray levels using a combination of the subfields. The driving apparatus includes a sustain pulse number determining unit, an inverse gamma corrector, a sustain pulse subfield converter, and a sustain/scan driver. The sustain pulse number determining unit determines a sustain pulse number based on an average signal level of data in one said field of the input image signal. The inverse gamma corrector performs inverse gamma correction of the input image signal to express an inverse gamma correction gray level corresponding to a number of sustain pulses applied to the plasma display panel, using one of a plurality of gamma correction tables that corresponds to the sustain pulse number determined by the sustain pulse number determining unit. The sustain pulse subfield converter converts the inverse gamma correction gray level to the subfields that depend on the sustain pulse number. The sustain/scan driver generates control signals based on an arrangement of the subfields and applies the control signals to the plasma display panel.

According to still another aspect of the present invention, there is provided a method for expressing gray levels of a plasma display panel that divides each field of an image displayed on the plasma display panel according to input image signal into a plurality of subfields and displays the image corresponding to the image signal by expressing gray levels using a combination of the subfields. In the method, a sustain pulse number is determined based on an average signal level of data in one said field of the input image signal. Inverse gamma correction of the input image signal is performed to express an inverse gamma correction gray level corresponding to a number of sustain pulses applied to the plasma display panel, using one of a plurality of gamma correction tables that corresponds to the sustain pulse number. The inverse gamma correction gray level is converted to the subfields that depend on the sustain pulse number. Control signals are generated based on an arrangement of the subfields to display the image on the plasma display panel.

According to still another aspect of the present invention, a plasma display device including a controller, a plasma display panel driver and a plasma display panel is provided. The controller receives an input image signal corresponding to an image having at least one field, and divides the at least one field into a plurality of subfields based on a maximum number of sustain pulses that are used to represent the image such that gray levels of as many as the maximum number can be expressed. The plasma display panel driver receives subfield data from the controller and generates control signals used to display the image. The plasma display panel displays the image corresponding to the control signals that are applied thereto by the plasma display panel driver.

### BRIEF DESCRIPTION OF THE DRAWINGS

The accompanying drawings, together with the specification, illustrate exemplary embodiments of the invention, and, together with the description, serve to explain the principles of the present invention, in which:

FIG. 1 is a partial perspective view of an alternating current type plasma display panel;

FIG. 2 shows an arrangement of the electrodes in the plasma display panel of FIG. 1;

FIG. 3 shows the gray level expressing method of a plasma display panel;

FIG. 4 is a schematic plan view of a plasma display panel according to exemplary embodiments of the present invention;

FIG. 5 is a schematic block diagram of a controller of a plasma display panel according to a first exemplary embodiment of the present invention;

FIG. 6 is a graph for illustrating inverse gamma correction performed by an inverse gamma corrector in the controller according to the first exemplary embodiment of the present invention;

FIG. 7 is a table showing the number of sustain pulses in respective subfields in the case where the number of the sustain pulses is 1023 and the number of the subfields is 10 at the sustain pulse subfield converter in the controller according to the first exemplary embodiment of the present invention;

FIG. 8 is a table showing the illuminating pattern that expresses the respective gray levels in the subfield arrangement method depending on the number of sustain pulses as shown in FIG. 7;

FIG. 9 is a schematic block diagram of a controller in a plasma display panel according to a second exemplary embodiment of the present invention;

FIG. 10 is a graph showing an example of the relation between the average signal level of frames and the number of the sustain pulses used in such a situation;

FIG. 11 is a graph showing an example in which an inverse gamma corrector in the controller of FIG. 9 changes the inverse gamma correction table according to the number of sustain pulses; and

FIG. 12 is a table showing the range used in the coding table concerning the subfield depending on the sustain pulse when the maximum sustain pulse number is 1023 in the case that the number of sustain pulses is 512.

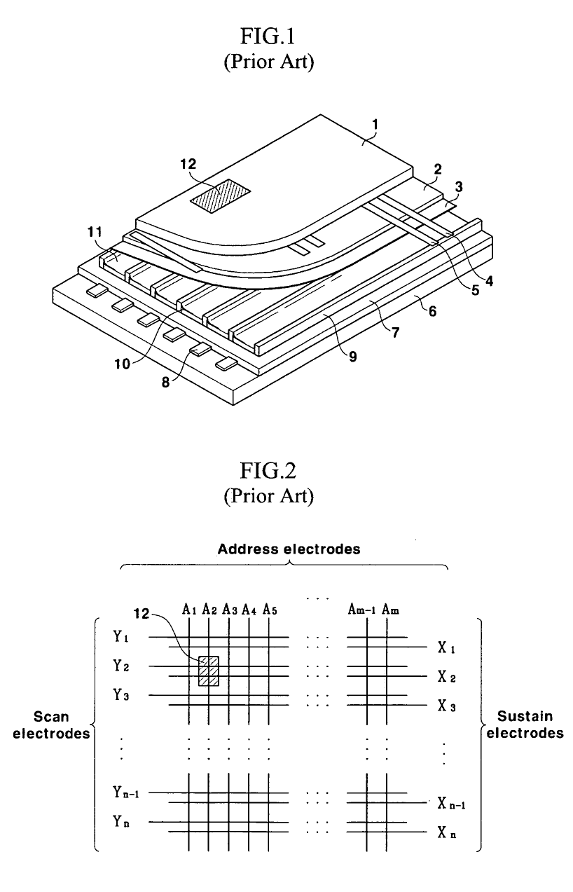

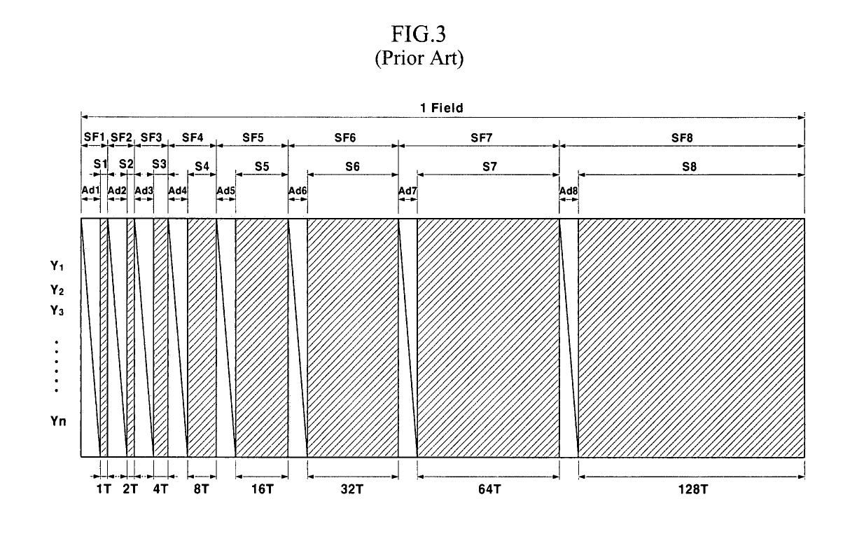

### DETAILED DESCRIPTION

In the following detailed description, only certain exemplary embodiments of the present invention are shown and described, simply by way of illustration. As those skilled in the art would realize, the present invention may be modified in various different ways, all without departing from the spirit or scope of the present invention. Accordingly, the drawings and description are to be regarded as illustrative in nature, and not restrictive.

To clarify the present invention, parts which are not described in the specification may have been omitted, and like elements are designated by like reference numerals.

Hereinafter, exemplary embodiments of the present invention will be described in greater detail with reference to the accompanying drawings.

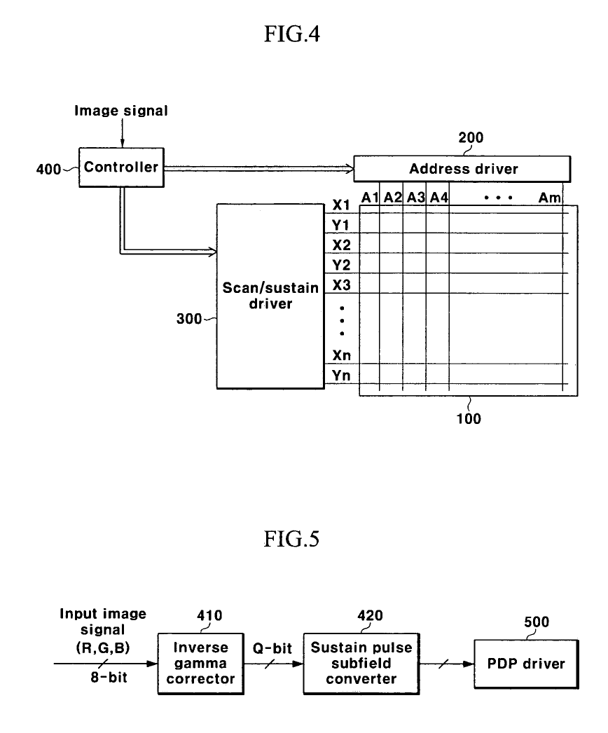

FIG. 4 is a schematic plan view of a plasma display panel according to exemplary embodiments of the present invention.

As shown in FIG. 4, the plasma display panel according to the exemplary embodiments of the present invention includes a plasma panel 100, an address driver 200, a scan/sustain driver 300, and a controller 400.

The plasma display panel 100 includes a plurality of address electrodes A1-Am that are arranged in a column direction, and a plurality of scan electrodes Y1-Yn and sustain electrodes X1-Xn that are arranged in a row direction alternately to each other. The address driver 200 receives address driving control signals from the controller 400, and applies display data signals for selecting discharge cells to be illuminated to the respective address electrodes A1-Am. The scan/sustain driver 300 receives the control signals from the controller 400 and inputs the sustain voltages to the scan electrodes Y1-Yn and the sustain electrodes X1-Xn by turns to perform the sustain discharge with respect to the selected discharge cells.

The controller 400 receives R/G/B image signals and synchronization signals from an external source and divides one frame into several subfields, and then divides the respective subfields into a reset time, addressing time, and sustain/discharge time to drive the plasma display panel. In such a situation, the controller 400 adjusts the number of sustain pulses applied in each of the sustain times of the subfields in one frame so as to supply the address driver 200 and the scan/sustain driver 300 with the required control signal.

Hereinafter, the controller 400 according to the exemplary embodiments of the present invention will be described in greater detail with reference to FIGS. 5 through 12.

FIG. 5 is a schematic block diagram of a controller of a plasma display panel according to a first exemplary embodiment of the present invention. The controller of FIG. 5, by way of example, may be used as the controller 400 of FIG. 4.

As shown in FIG. 5, the controller of the plasma display panel according to the first exemplary embodiment of the present invention includes an inverse gamma corrector 410 and a sustain pulse subfield converter 420.

The inverse gamma corrector 410 performs mapping of the input image signals having n-bits to the inverse gamma curve to correct the input image signal to the image signal having Q-bits. As the general number of bits is 8, the case where the input image signal includes 8 bits will be illustrated here. In such a situation, the input image signal having 8 bits is corrected to Q-bits, and the inverse gamma corrector 410 determines the output of the inverse gamma correction according to the number of sustain pulses that are determined arbitrarily. The Q-bits that are output bits of the inverse gamma corrector 410 is determined by Equation (1) below.
2^{Q-1}≦P<2^{Q} [Equation (1)]

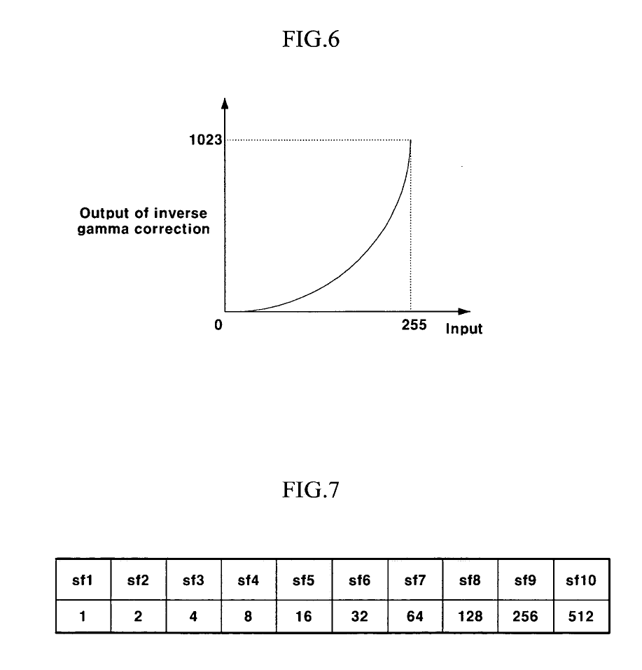

In Equation (1), P refers to a number of sustain pulses determined arbitrarily. For example, if the number of sustain pulses is 1023, the magnitude of the output data becomes 10-bits according to Equation (1), and the look-up table of the inverse gamma corrector 410 is determined as in FIG. 6. In other words, the inverse gamma correction gray level corresponding to the number of sustain pulses is expressed by the inverse gamma corrector 410.

In such a situation, the image signal input to the inverse gamma corrector 410 is a digital signal, so the analog image signal should be converted to a digital signal by an analog-to-digital converter (not shown) when the analog image signal is input to the plasma display panel. The inverse gamma corrector 410 may include a logic circuit (not shown) for logically generating data corresponding to the inverse gamma curve or a look-up table (not shown) that stores the data corresponding to the inverse gamma curve for the mapping of the image signal.

The sustain pulse subfield converter 420 converts the inverse gamma correction gray level corresponding to the number of sustain pulses output from the inverse gamma corrector 410 to the subfields depending on the number of sustain pulses. In other words, whereas conversion to the subfields have been made in consideration of gray level in the conventional art, conversion to the subfields are made in consideration of the number of sustain pulses in the described embodiment of the present invention. For example, when the number of sustain pulses is 1023 as above and the number of subfields is 10, the arrangement of the sustain pulse subfield as shown in FIG. 7 can be employed.

FIG. 7 is a table showing the number of sustain pulses in respective subfields in the case where the number of the sustain pulses is 1023 and the number of subfields is 10 at the sustain pulse subfield converter 420 in the controller according to the first exemplary embodiment of the present invention. As shown in FIG. 7, the respective subfields sf1, sf2, . . . , and sf10 do not have weight values but have the number of sustain pulses. Accordingly, gray levels of as many as the number of sustain pulses are expressed. That is, if the number of sustain pulses is 1023, the gray level can be expressed by 1024 steps that are the same as the number of sustain pulses.

According to the arrangement method of subfields depending on the number of sustain pulses as shown in FIG. 7, all from 0 to 1023 can be expressed at intervals of 1 by adjusting the illuminating pattern of the respective subfields. That is, 1024 steps of gray level can be expressed if the total number of sustain pulses is 1023.

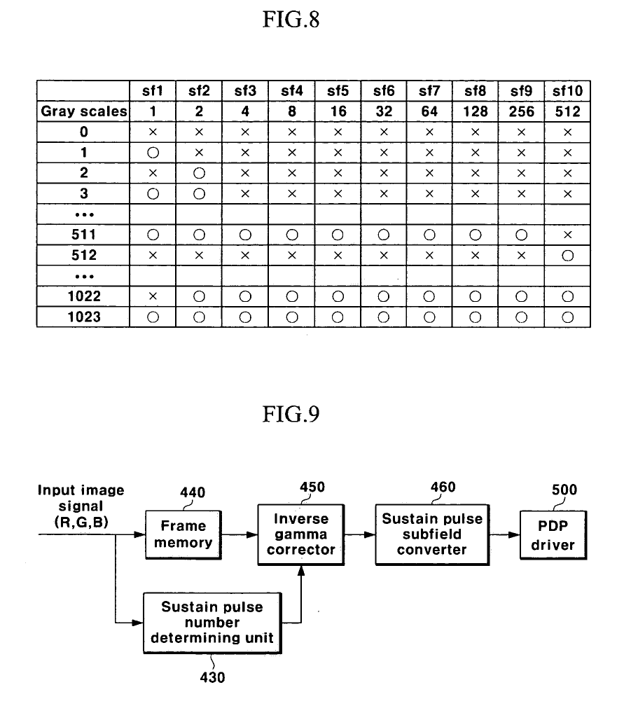

FIG. 8 is a table which shows the illuminating pattern that expresses the respective gray levels in the subfield arrangement method depending on the number of sustain pulses as shown in FIG. 7. In order to express the gray level 1, as shown in FIG. 8, only the subfield sf1 having one sustain pulse is illuminated to express that gray level. For example, the gray level 1 is expressed by one sustain pulse, and the gray level 2 is expressed by two sustain pulses.

Therefore, according to the subfield arrangement method depending on the sustain pulses performed by the controller of the first exemplary embodiment of the present invention, gray levels of as many as the number of sustain pulses can be expressed to improve the performance of expressing the gray level. In other words, the first exemplary embodiment of the present invention can improve or maximize the performance to express the gray level by determining the arrangement of the sustain pulse subfield according to the number (determined arbitrarily) of the maximum sustain pulses, without any additional calculation such as an error diffusion method.

The subfield data (sustain pulse number data) of the subfield arrangement depending on the number of sustain pulses converted by the sustain pulse subfield converter 420 are transmitted to the PDP driver 500, i.e., the address driver 200 and the scan/sustain driver 300, to be displayed on the plasma display panel 100.

The case in which the sustain pulse number (which means the maximum sustain pulse number) is fixed arbitrarily has been described so far. Hereinafter, however, a description of a controller of a plasma display panel where the gray level expression method depends on the sustain pulses, in which the sustain pulse number is determined according to the average signal level ASL at every frame in the plasma display panel, is provided.

FIG. 9 is a schematic block diagram of a controller of a plasma display panel according to a second exemplary embodiment of the present invention. The controller of FIG. 9, by way of example, may be used as the controller 400 of FIG. 4 as an alternative to the controller of FIG. 5.

As shown in FIG. 9, the controller in the plasma display panel according to the second exemplary embodiment of the present invention includes a sustain pulse number determining unit 430, a frame memory 440, an inverse gamma corrector 450, and a sustain pulse subfield converter 460.

The sustain pulse number determining unit 430 determines the number of sustain pulses at every frame of the input image signal. That is, the sustain pulse number determining unit 430 determines the maximum sustain pulse number in consideration of the luminance and power consumption. The average signal level ASL at every frame is calculated in order to determine the sustain pulse number by the following Equation (2):

$$ASL = {\sum }_{x = 1}^{N} {\sum }_{y = 1}^{M} \frac{{R}_{x , y} + {G}_{x , y} + {B}_{x , y}}{3 \times N \times M} \qquad [ Equation ( 2 ) ]$$

In the above Equation (2), R_{x,y}, G_{x,y}, and B_{x,y} respectively designate the R/G/B gray levels at the position x,y, and N and M respectively designate the horizontal and vertical size of the frame. The sustain pulse number determining unit 430 determines the sustain pulse number at every frame of the input image signal differently from each other in consideration of the aspect of the luminance and the power consumption through the average signal level ASL calculated by Equation (2).

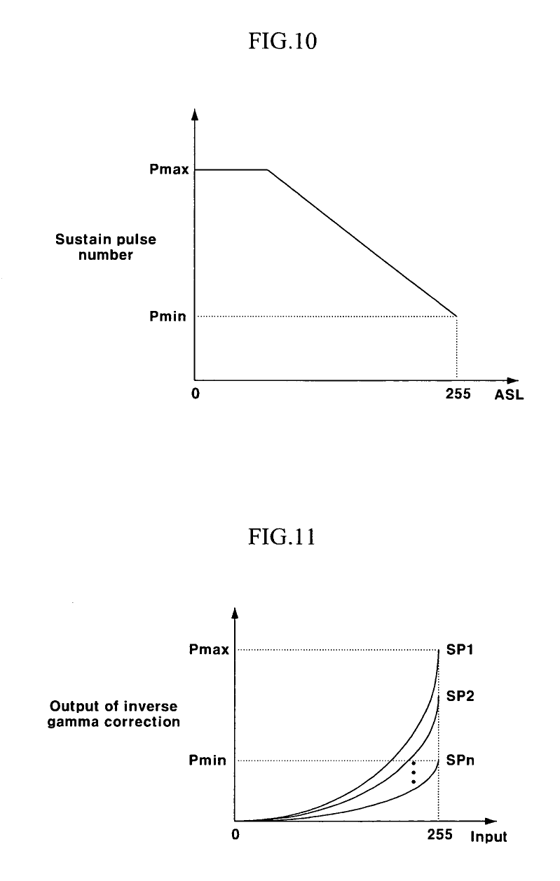

FIG. 10 is a graph showing an example of the relation between the average signal level of frames and the number of the sustain pulses used in such a situation. As shown in FIG. 10, a great number of sustain pulses are used to enhance the peak luminance if the average gray level of frames is low, and a small number of sustain pulses are used to reduce the power consumption if the average gray level is high.

In this situation, the number of expressed gray levels is reduced if the sustain pulse number is reduced, however, as shown in FIG. 10, the sustain pulse number is reduced mainly at the image of a bright average gray level, and the sustain pulse number is increased in a dark image that bears frequent problems in expressing the gray level. Therefore, by adjusting the sustain pulse number (i.e., the maximum sustain pulse number) according to the average signal level ASL of a frame, the expression of the gray level is enhanced.

The inverse gamma corrector 450 performs the inverse gamma correction according to the sustain pulse number (which is determined by the average signal level of the input image signal) determined by the sustain pulse determining unit 430. In other words, one among a plurality of look-up tables (which represent gamma curves) is selected as required according to the sustain pulse number determined by the sustain pulse determining unit 430 and is then used. FIG. 11 is a graph showing an example in which the inverse gamma corrector 450 changes the inverse gamma correction table according to the number of sustain pulses. As shown in FIG. 11, if the sustain pulse number is maximum Pmax, the inverse gamma correction is performed with reference to the inverse gamma correction look-up table SP1. In other words, the inverse gamma correction is performed by selecting one of the different inverse gamma curves according to the sustain pulse number.

In that situation, the inverse gamma corrector 450 outputs the result of inverse gamma correction corresponding to the sustain pulse number in the same manner as the inverse gamma corrector 410 of the first exemplary embodiment of the present invention, except for the fact that the inverse gamma corrector 450 changes the inverse gamma table according to the sustain pulse number determined by the average signal of the input image signal.

The frame memory 440 stores and delays the data of the frame input at present by as much as the time required for the sustain pulse number determining unit 440 to determine the sustain pulse number.

The sustain pulse subfield converter 460 converts the inverse gamma correction result corresponding to the sustain pulse number output by the inverse gamma corrector 450 to the subfield information. In such a situation, the sustain pulse subfield converter 460 determines and uses the sustain pulse subfield arrangement regarding the maximum sustain pulse number (which means the sustain pulse number when the maximum number of sustain pulses are used as the average signal level of the input image signal is lowest), and has the coding table (the number of sustain pulses of the respective subfields and the expression of the gray level according thereto) on the basis of the maximum sustain pulse number. For example, if the number Pmax of maximum sustain pulses is 1023, the subfield arrangement depending on the sustain pulses as shown in FIG. 7 can be used. The coding table, i.e., the number of sustain pulses in respective subfields and the expression of gray level according thereto, in such a case is as in FIG. 8. Further, if the number of sustain pulses determined by the sustain pulse determining unit 430 is smaller than 1023, that is, if an inverse gamma correcting curve lower than Pmax in FIG. 11 is used, the coding regarding the output value of the corresponding pulse in the coding table as shown in FIG. 8 can be determined since the maximum output value is not greater than the maximum pulse number, 1023.

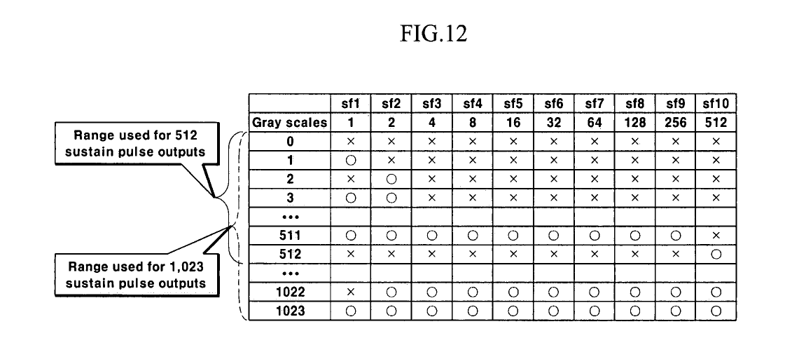

FIG. 12 is a table showing the range used in the coding table concerning the subfield depending on the sustain pulse when the maximum sustain pulse number is 1023 in the case where the number of sustain pulses is 512. As shown in FIG. 12, if the sustain pulse number is 512, the gray level can be expressed using a part of the coding table as shown in FIG. 12. Similarly, all of the output is supported by the same coding table regarding the other sustain pulse numbers smaller than 1023.

The subfield data (sustain pulse number data) with the subfield arrangement depending on the sustain pulse number converted by the sustain pulse subfield converter 420 are transmitted to the PDP driver 500, that is, the address driver 200 and the scan/sustain driver 300, and then displayed on the plasma display panel 100.

As described above, according to the present invention, the subfield arrangement performing the optimal gray level expression according to the sustain pulse number is used, so the gray level expression performance can be improved without any other additional calculations such as error diffusion. Further, there is provided a feature that the performance to express the gray level can be improved much more as the number of sustain pulses increases.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A driving apparatus for a plasma display panel that divides each field of an image displayed on the plasma display panel according to an input image signal into a plurality of subfields and displays the image corresponding to the image signal by expressing gray levels using a combination of the subfields, the driving apparatus comprising:
an inverse gamma corrector that performs inverse gamma correction of the input image signal to express an inverse gamma correction gray level corresponding to a number of sustain pulses applied to the plasma display panel;
a sustain pulse subfield converter that converts the inverse gamma correction gray level to the subfields that depend on the number of sustain pulses; and
a sustain/scan driver that generates control signals based on an arrangement of the subfields and applies the control signals to the plasma display panel.

2. The driving apparatus of claim 1, wherein a number of bits in the inverse gamma correction gray level is determined by a maximum sustain pulse number applied to the plasma display panel.

3. The driving apparatus of claim 1, wherein the gray levels that can be expressed by the combination of the subfields are determined by a maximum sustain pulse number applied to the plasma display panel.

4. The driving apparatus of claim 1, wherein a number of the subfields that the inverse gamma correction gray level can be converted to by the sustain pulse subfield converter is determined by a maximum sustain pulse number applied to the plasma display panel.

5. A method for expressing gray levels of a plasma display panel that divides each field of an image displayed on the plasma display panel according to an input image signal into a plurality of subfields and displays the image corresponding to the image signal by expressing gray levels using a combination of the subfields, the method comprising:
(a) performing inverse gamma correction of the input image signal to express an inverse gamma correction gray level corresponding to a number of sustain pulses applied to the plasma display panel;
(b) converting the inverse gamma correction gray level to the subfields that depend on the number of sustain pulses; and
(c) generating control signals based on an arrangement of the subfields to display the image on the plasma display panel.

6. The method of claim 5, wherein the gray levels that can be determined by the combination of the subfields are determined by a maximum sustain pulse number applied to the plasma display panel.

7. The method of claim 5, wherein a number of the subfields that the inverse gamma correction gray level can be converted to is determined by a maximum sustain pulse number applied to the plasma display panel.

8. A driving apparatus for a plasma display panel that divides each field of an image displayed on the plasma display panel according to an input image signal into a plurality of subfields and displays the image corresponding to the image signal by expressing gray levels using a combination of the subfields, the driving apparatus comprising:
a sustain pulse number determining unit that determines a sustain pulse number based on an average signal level of data in one said field of the input image signal;
an inverse gamma corrector that performs inverse gamma correction of the input image signal to express an inverse gamma correction gray level corresponding to a number of sustain pulses applied to the plasma display panel, using one of a plurality of gamma correction tables that corresponds to the sustain pulse number determined by the sustain pulse number determining unit;
a sustain pulse subfield converter that converts the inverse gamma correction gray level to the subfields that depend on the sustain pulse number; and
a sustain/scan driver that generates control signals based on an arrangement of the subfields and applies the control signals to the plasma display panel.

9. The driving apparatus of claim 8, wherein the sustain pulse subfield converter determines a sustain pulse subfield arrangement corresponding to the sustain pulse number determined by the sustain pulse number determining unit.

10. The driving apparatus of claim 8, wherein the sustain pulse number determining unit determines the sustain pulse number to be small when the average signal level is high, and the sustain pulse number to be large when the average signal level is low.

11. The driving apparatus of claim 9, wherein the sustain pulse number determining unit determines the sustain pulse number to be small when the average signal level is high, and the sustain pulse number to be large when the average signal level is low.

12. The driving apparatus of claim 8, wherein the gray levels that can be determined by the combination of the subfields by the sustain pulse subfield converter are determined by the sustain pulse number determined by the sustain pulse number determining unit.

13. The driving apparatus of claim 9, wherein the gray levels that can be determined by the combination of the subfields by the sustain pulse subfield converter is determined by the sustain pulse number determined by the sustain pulse number determining unit.

14. A method for expressing gray levels of a plasma display panel that divides each field of an image displayed on the plasma display panel according to an input image signal into a plurality of subfields and displays the image corresponding to the image signal by expressing gray levels using a combination of the subfields, the method comprising:
(a) determining a sustain pulse number based on an average signal level of data in one said field of the input image signal;
(b) performing an inverse gamma correction of the input image signal to express an inverse gamma correction gray level corresponding to a number of sustain pulses applied to the plasma display panel, using one of a plurality of gamma correction tables that corresponds to the sustain pulse number;
(c) converting the inverse gamma correction gray level to the subfields that depend on the sustain pulse number; and
(d) generating control signals based on an arrangement of the subfields to display the image on the plasma display panel.

15. The method of claim 14, wherein the arrangement of the subfields corresponds to the sustain pulse number.

16. The method of claim 14, wherein the gray levels that can be determined by the combination of the subfields are determined by the sustain pulse number.

17. The method of claim 15, wherein the gray levels that can be determined by the combination of the subfields are determined by the sustain pulse number.

18. A plasma display device comprising:
a controller for receiving an input image signal corresponding to an image having at least one field, and for dividing the at least one field into a plurality of subfields based on a maximum number of sustain pulses that are used to represent the image such that gray levels of as many as the maximum number can be expressed;
a plasma display panel driver for receiving subfield data from the controller and generating control signals used to display the image; and
a plasma display panel for displaying the image corresponding to the control signals that are applied thereto by the plasma display panel driver.

19. The plasma display device of claim 18, wherein the maximum number is arbitrarily assigned.

20. The plasma display device of claim 18, wherein the maximum number is determined based on an average signal level of the at least one field.
